(19) United States
(12) Patent Application Publication
(10) Pub. No.: US 2014/0322692 A1
(43) Pub. Date: Oct. 30, 2014

(54) METHODS FOR ONLINE EDUCATION

(71) Applicant: Study Social, Inc., Gainesville, FL (US)

(72) Inventor: Ethan Fieldman, Gainesville, FL (US)

(21) Appl. No.: 14/216,688

(22) Filed: Mar. 17, 2014

Related U.S. Application Data
(60) Provisional application No. 61/799,332, filed on Mar. 15, 2013.

(51) Int. Cl. G09B 7/00

(52) U.S. Cl. CPC G09B 7/00
USPC 434/322

(57) ABSTRACT

The present invention is generally directed to a variety of tools, programs and methods for presenting or enhancing an online learning environment for a student viewing or participating in an online learning session. One embodiment is directed to a method of matching instructors and students by utilizing commonalities (or lack thereof) with a social media site and by having the student take a personality test to determine how the student learns most efficiently. Another embodiment is directed to a method of certifying instructors that want to teach an online course. And yet another embodiment is directed to a method presenting an online learning session to students using and toggling between varieties of viewing formats.

### FIELD OF THE INVENTION

The present invention generally relates to an online education program in which a student may selectively choose an instructor (e.g., teacher or tutor) based on a variety of factors, and additionally an online education program that provides a variety of interactive learning methods between the student(s) and the instructor.

### BACKGROUND

Online learning has grown dramatically in the recent decade with advances in computational speed and advances in media transmission. In an algebra class for example, a conventional learning technique for students who were not present in a classroom was watching videos or digital video discs (DVDs) showing an instructor teaching the subject matter. While a student could watch the video at his or her own pace, there was little to no interaction between the student and the instruction during the real-time teaching of the subject matter. While online learning has become more mainstream, there are still a variety of drawbacks with how and when a student may interact with an instructor, how a student may select an instructor that is a “best-fit” for the student, and a variety of other problems.

### BRIEF SUMMARY OF THE INVENTION

The present invention is generally directed toward an online education program aimed at helping students with a variety of courses, test preparations, and end-of-course (EOC) exams such as, but not limited to Algebra. Last year, fifty-percent (50%) of high school students who took Florida's Algebra 1 EOC failed. In high needs schools, the results were even more alarming—over eighty-percent (80%) of students did not pass the test. In response, embodiments of the present invention allow for partnerships between a learning institution and a vendor that provides ongoing collaboration among teachers, professors, administrators, parents, and students.

In one embodiment, the vendor or the learning institution themselves may provide the learning institution with videos that break down selected problems and provide a corresponding study guide so students can follow along at their own pace. The videos may prompt students to pause and try out problems independently. The videos may also encourage collaboration by asking higher order questions that students can then answer on a virtual wall (e.g., post).

The online education program provides one system with access to all features simultaneously. The user can pause a video and ask a question on wall in real-time, instead of waiting to get an answer the next day in class, from their teacher. Or instead of waiting to see if the instructor covers the material later. The key is there there's a community with immediate feedback from peers and tutors.

Learning does not happen in a vacuum. The best use of technology breaks down barriers and classroom walls. Students, teachers, and parents are no longer confined to the hours of a school day or the constraints of physical location. Students can ask questions on their computers and/or smartphones, and will receive answers from instructors such as, but not limited to, professors, teachers, peers, tutors and other teaching aides. In one embodiment, activities and questions from students may be monitored in real time, and instructors may choose to receive a report of their student's questions and answers. By way of example, the vendor's interactive wall may mimic a social media site such as FACEBOOK® because many of today's students are already familiar and comfortable with one or more social media environments.

In one aspect of the present invention, a method for matching instructors and students includes the steps of (1) generating a database of instructors from one or more learning institutions; (2) determining whether an instructor is friends with or has mutual friends with a student; (3) providing a personality test to the student to determine a learning type of the student; and (4) permitting the student to select an instructor.

In another aspect of the invention, a method for instructor certification from a learning institution includes the steps of (1) receiving a request for a new certification from an instructor; (2) evaluating the request for the new certification; and (3) determining whether the request should be accepted or rejected.

In yet another aspect of the invention, a method for instructor certification from a learning institution includes the steps of (1) receiving a request for a certification from an instructor, wherein the instructor believes that the instructor is pre-certified; (2) verifying the request for the certification; and (3) determining whether the request should be accepted or rejected.

In still yet another aspect of the invention, a method for viewing an online learning session includes the steps of (1) commencing an online learning session in which an instructor is initially viewable by the students through a face camera; (2) toggling a viewing format of the online learning session to a picture-in-picture (PIP) viewing format; and (3) depending on subject being taught by the instructor, selectively toggling the viewing format between the PIP viewing format, the face camera viewing format, and a document camera viewing format.

### BRIEF DESCRIPTION OF THE DRAWINGS

Preferred and alternative embodiments of the present invention are described in detail below with reference to the following drawings:

FIG. 1 is a schematic system diagram showing a computing system usable to carry out various other actions or methods in accordance with the present invention;

FIG. 2 is flow diagram of a method for matching instructors and students according to an embodiment of the present invention;

FIG. 3 is a flow diagram of a method for instructor certification according to an embodiment of the present invention;

FIG. 4 is a flow diagram of a method searching a database having instructor-created course codes according to an embodiment of the present invention;

FIG. 5A is a method for viewing an online learning session according to an embodiment of the present invention;

FIG. 5B is a perspective view of a learning session as seen by a student according to an embodiment of the present invention;

FIG. 5C is a perspective view of another learning session as seen by a student according to an embodiment of the present invention;

FIG. 6 shows a stylus according to an embodiment of the present invention; and

FIG. 7 shows a dot created by the stylus of FIG. 6 according to an embodiment of the present invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known systems and methods associated with online education programs, modules and learning techniques may not necessarily be shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

In addition, throughout the specification and claims which follow, the word “instructor” is meant as a broad term that includes a variety of people who may teach a particular subject matter, a tutor that assist a student with learning a particular subject matter or any other person that may assist in instructing, teaching or tutoring. Likewise, the word “student” is meant as a broad term that includes potential students, tutees, and any other persons that may desire to learn about a particular subject matter. The term “learning institution” is meant as a broad term that includes any company, college, university, community college, technical school, high school, or any entity involved in providing subject matter for the purposes of education.

The headings provided herein are for convenience only and do not interpret the scope or meaning of the claimed invention

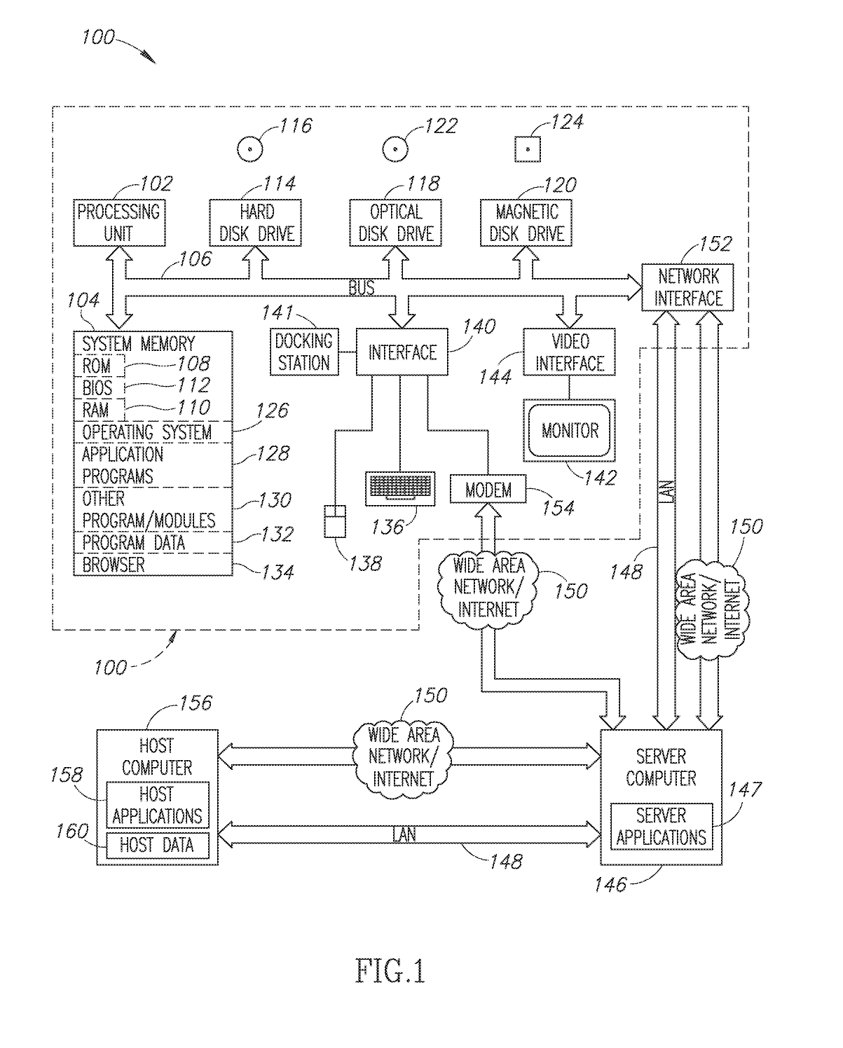

FIG. 1 in cooperation with the following provides a general description of a computing environment that may be used to implement various aspects of the present invention. For purposes of brevity and clarity, embodiments of the invention may be described in the general context of computer-executable instructions, such as program application modules, objects, applications, models, or macros being executed by a computer, which may include but is not limited to personal computer systems, hand-held devices, multiprocessor systems, microprocessor-based or programmable consumer electronics, network PCs, mini computers, mainframe computers, and other equivalent computing and processing sub-systems and systems. Aspects of the invention may be practiced in distributed computing environments where tasks or modules are performed by remote processing devices linked through a communications network. Various program modules, data stores, repositories, models, federators, objects, and their equivalents may be located in both local and remote memory storage devices.

By way of example, a conventional personal computer, referred to herein as a computer 100, includes a processing unit 102, a system memory 104, and a system bus 106 that couples various system components including the system memory to the processing unit. The computer 100 will at times be referred to in the singular herein, but this is not intended to limit the application of the invention to a single computer since, in typical embodiments, there will be more than one computer or other device involved. The processing unit 102 may be any logic processing unit, such as one or more central processing units (CPUs), digital signal processors (DSPs), application-specific integrated circuits (ASICs), etc.

The system bus 106 can employ any known bus structures or architectures, including a memory bus with memory controller, a peripheral bus, and a local bus. The system memory 104 includes read-only memory (“ROM”) 108 and random access memory (“RAM”) 110. A basic input/output system (“BIOS”) 112, which can form part of the ROM 108, contains basic routines that help transfer information between elements within the computer 100, such as during start-up.

The computer 100 also includes a hard disk drive 114 for reading from and writing to a hard disk 116, and an optical disk drive 118 and a magnetic disk drive 120 for reading from and writing to removable optical disks 122 and magnetic disks 124, respectively. The optical disk 122 can be a CD-ROM, while the magnetic disk 124 can be a magnetic floppy disk or diskette. The hard disk drive 114, optical disk drive 118, and magnetic disk drive 120 communicate with the processing unit 102 via the bus 106. The hard disk drive 114, optical disk drive 118, and magnetic disk drive 120 may include interfaces or controllers (not shown) coupled between such drives and the bus 106, as is known by those skilled in the relevant art. The drives 114, 118, 120, and their associated computer-readable media, provide nonvolatile storage of computer readable instructions, data structures, program modules, and other data for the computer 100. Although the depicted computer 100 employs hard disk 116, optical disk 122, and magnetic disk 124, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 104, such as an operating system 126, one or more application programs 128, other programs or modules 130 and program data 132. The application programs 128, program or modules 130, and program data 132 may include information, instructions and parameters for creating, manipulating, scoring, ranking, uploading, and processing information to determine a best-fit match between students and instructors, to determine a certification of a tutor, provide filtering by a course code, content protection and dissemination restrictions, etc. The system memory 104 may also include a browser 134 for permitting the computer 100 to access and exchange data with sources such as web sites of the Internet, corporate intranets, or other networks as described below, as well as other server applications on server computers such as those further discussed below. In one embodiment, the browser 134 may be used to access course materials, view a tutor, and share information (e.g., questions or comments) with a tutor or otherwise build-up databases of information that may be customizably utilized for a variety of purposes in a learning environment as will be described in greater detail below. The browser 134 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the computer 100 as a personal computer, in other embodiments, the computer is some other computer-related device such as a tablet, a television, a personal data assistant (PDA), a cell phone (or other mobile devices).

The operating system 126 may be stored in the system memory 104, as shown, while application programs 128, other programs/modules 130, program data 132, and browser 134 can be stored on the hard disk 116 of the hard disk drive 114, the optical disk 122 of the optical disk drive 118, and/or the magnetic disk 124 of the magnetic disk drive 120. A user can enter commands and information into the computer 100 through input devices such as a keyboard 136 and a pointing device such as a mouse 138. Other input devices can include a microphone, joystick, game pad, scanner, etc. These and other input devices are connected to the processing unit 102 through an interface 140 such as a serial port interface that couples to the bus 106, although other interfaces such as a parallel port, a game port, a wireless interface, or a universal serial bus (“USB”) can be used. Another interface device that may be coupled to the bus 106 is a docking station 141 configured to receivably and electronically engage a digital pen or stylus for the purpose of data transmission, charging, etc. A monitor 142 or other display device is coupled to the bus 106 via a video interface 144, such as a video adapter. The computer 100 can include other output devices, such as speakers, printers, etc.

The computer 100 can operate in a networked environment using logical connections to one or more remote computers, such as a server computer 146. The server computer 146 can be another personal computer, a server, another type of computer, or a collection of more than one computer communicatively linked together and typically includes many or all the elements described above for the computer 100. The server computer 146 is logically connected to one or more of the computers 100 under any known method of permitting computers to communicate, such as through a local area network (“LAN”) 148, or a wide area network (“WAN”) or the Internet 150. Such networking environments are well known in wired and wireless enterprise-wide computer networks, intranets, extranets, and the Internet. Other embodiments include other types of communication networks, including telecommunications networks, cellular networks, paging networks, and other mobile networks. The server computer 146 may be configured to run server applications 147.

When used in a LAN networking environment, the computer 100 is connected to the LAN 148 through an adapter or network interface 152 (communicatively linked to the bus 106). When used in a WAN networking environment, the computer 100 often includes a modem 154 or other device, such as the network interface 152, for establishing communications over the WAN/Internet 150. The modem 154 may be communicatively linked between the interface 140 and the WAN/Internet 150. In a networked environment, program modules, application programs, or data, or portions thereof, can be stored in the server computer 146. In the depicted embodiment, the computer 100 is communicatively linked to the server computer 146 through the LAN 148 or the WAN/Internet 150 with TCP/IP middle layer network protocols; however, other similar network protocol layers are used in other embodiments. Those skilled in the relevant art will readily recognize that the network connections are only some examples of establishing communication links between computers, and other links may be used, including wireless links.

The server computer 146 is further communicatively linked to a legacy host data system 156 typically through the LAN 148 or the WAN/Internet 150 or other networking configuration such as a direct asynchronous connection (not shown). Other embodiments may support the server computer 146 and the legacy host data system 156 on one computer system by operating all server applications and legacy host data system on the one computer system. The legacy host data system 156 may take the form of a mainframe computer. The legacy host data system 156 is configured to run host applications 158, such as in system memory, and store host data 160 such as business related data.

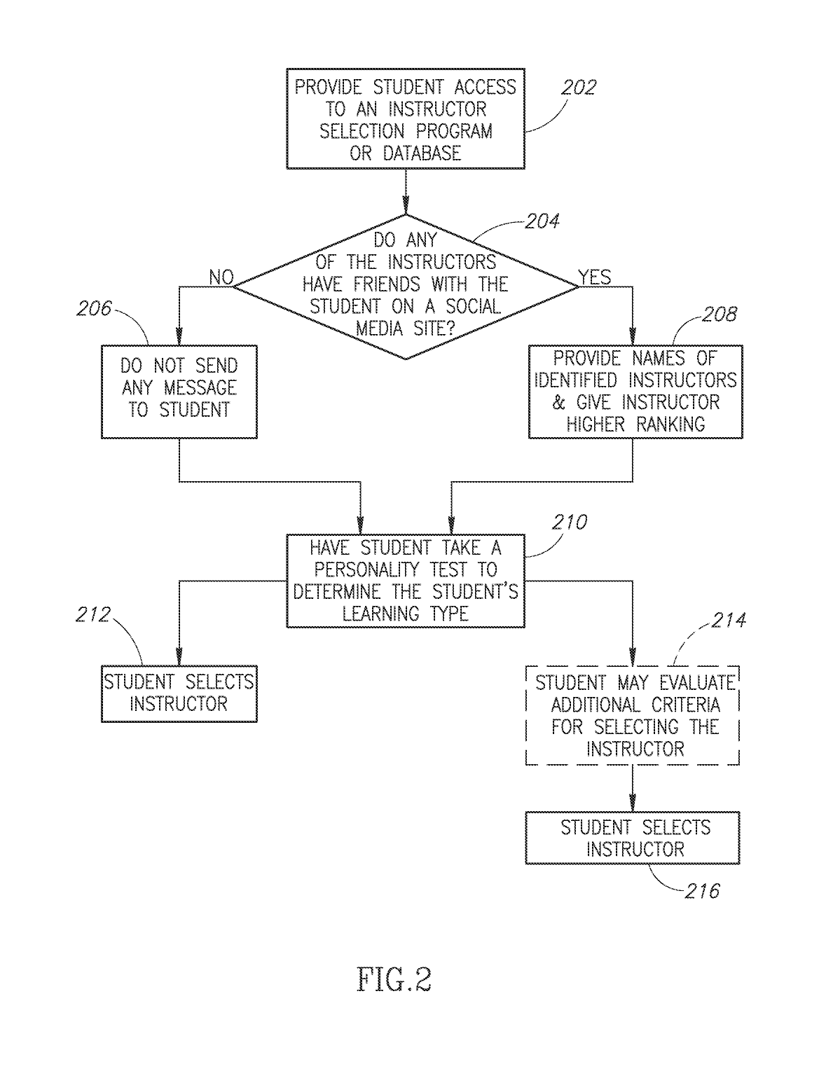

FIG. 2 shows a tutor matching method 200 for matching students or potential students with instructors according to an embodiment of the present invention. For purposes of brevity and clarity herein, a student will be referred to as tutee and an instructor will be referred to as a tutor. Preferably, the purpose of the tutor matching method 200 is to find a best-fit or even an optimal match between a student and an instructor (e.g., a tutor) as quickly as possible. In one embodiment, tutors that are a better match for the tutee are ranked higher in the student's search results. In addition, the tutors may be scored relative to each other using a “matching score.”

At Step 202, tutees are provided access to a tutor selection program and/or database for a particular learning institution or among a variety of tutee selected learning institutions. At Step 204, a program or application determines whether any of the tutors are friends with the tutee on a social media site or have mutual friends or mutual interests in common with the tutee on a social media site. In one embodiment, the social media site may take the form of a FACEBOOK® social media site. If the tutee and tutor are not friends and/or if they do not have any friends in common, then at Step 206 the matching method 200 does not preferably inform the tutee, meaning that the matching method 200 may optionally not return any results to the tutee (i.e., the matching method 200 does not provide anything ominous like “no mutual friends”). In another embodiment, the matching method 200 may return a result to the tutee indicating that no mutual friend matches were found.

If the tutee and tutor are friends and/or if they do have any friends in common, then at Step 208 the matching method 200 will provide those tutors' names to the tutee and will also give such tutors a higher ranking. In one embodiment, Step 208 may also provide the tutee with the ability to see images, profiles or bios of the tutee or tutees that share mutual friends with the tutee. Advantageously, Step 208 introduces a social element to the tutor matching method 200 to help the tutee feel more secure. Finding tutors is primarily based on academic credentials (e.g., I've been teaching Biology for five years). The tutor matching method 200 introduces a social element because peers often have similar interests (e.g., similar majors) and preferences/constraints (e.g., learning styles, schedules), and such peers often do or are able to recommend tutors. The tutor matching method 200 creates an easy way to see who has hired tutors previously, and better gauge of if tutor would be suitable than a conventional star system or “references available upon request.” The tutor matching method 200 may also provide a synthesis of academic information with social information (e.g., liking specific academic subjects, etc.). In one embodiment, a learning environment mimics a social media site to encourage social behavior within academics. Tutees may advantageously find studying more enjoyable and stay engaged longer, which results in better learning outcomes.

The tutor matching method 200 may or may not give the instructor a higher ranking based on having mutual friends. One purpose of identifying mutual friends and notifying the tutee of such is so the tutee may feel safer that they have friends who know the instructor and the tutee can message the mutual friend to check on quality.

At Step 210, the tutee may be given a personality test or quiz to determine the tutee's type of learning style. In one embodiment, the tutee is given a quasi-Meyers-Briggs or other type of personality test that has been customized to determine whether the tutee is a bottom-up or top-down learner (i.e., whether the tutee learns better by having examples first or by having concepts first, respectively). Knowing the learning type of the tutee may factor into the ranking or score of the tutor depending on whether the tutor prefers to provide examples first or concepts first in a teaching environment. The instructor may be given the results of the student's learning style quiz, so the instructor may adapt how they are teaching to best accommodate the learning style of the student.

Based on the ranking of the tutor at this point, at Step 212 the tutee may select a tutor. Alternatively and at Step 214, the tutee may choose to evaluate additional criteria before selecting a tutor. Additional criteria that may be evaluated by the tutor matching method 200 are criteria such as, but not limited to, a tutor's ratings from previous classes or sessions, the tutor's school (e.g., whether the tutor's learning institution is ranked higher by an independent or objective ranking system as compared to another tutor's learning institution or as compared to the tutee's learning institution), the tutor's total hours or years of teaching experience (e.g., higher is better). Additionally or alternatively, other types of criteria may take the form of a certification or certifications from the tutor's learning institution, social data from one or more social media sites, and a session rating history.

The tutor matching method 200 may use the various criteria mentioned above to provide a ranking or scoring for a plurality of tutors. At step 216, the tutee may select a tutor based on the ranking or scoring result provide by the tutor matching method 200. The steps described herein may be re-arranged in a different order and/or some steps may be removed. For example, if the student matches well on personality with the instructor then it might not matter if the student and instructor have mutual. In another example, the student does not necessarily have to see if they have mutual friends or not, and the student may not necessarily take personality test. By way of example, the student may want the instructor with the highest score or rank, which may be determined using a combination of price, quality reviews/ratings, and the personality test as well as other factors. The student may select an instructor or merely message a bunch of the highest rated instructors to gather more information and then make a selection later.

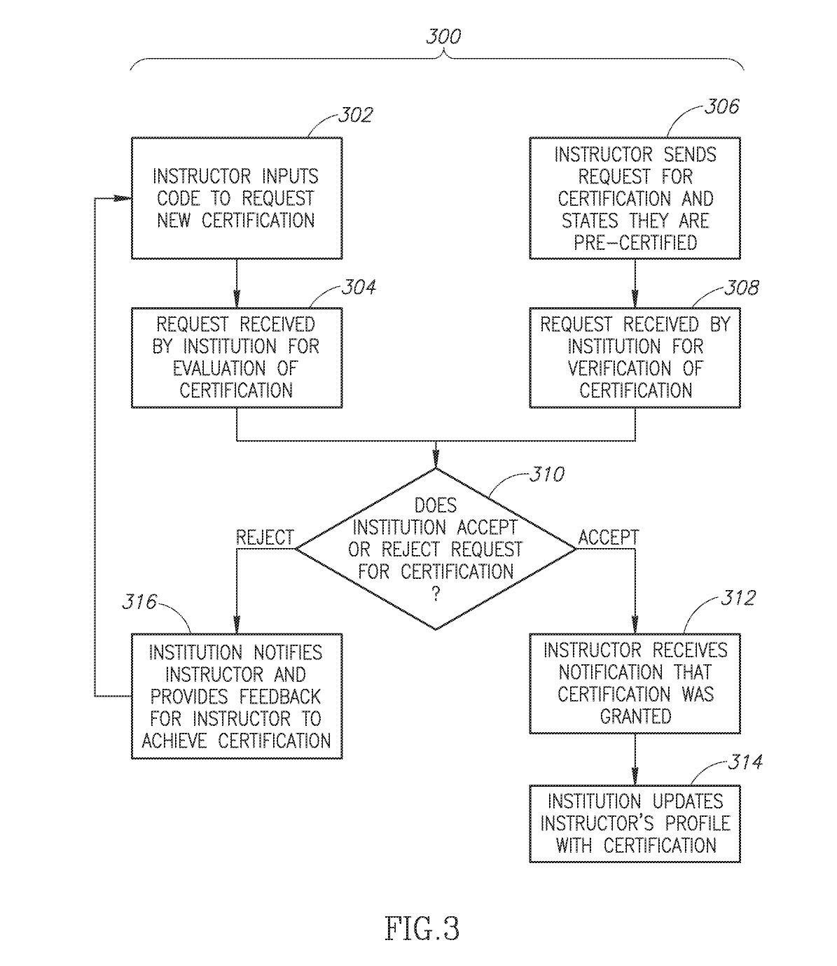

FIG. 3 shows a diagram for an instructor certification method 300 according to an embodiment of the present invention. For a new instructor certification request, at Step 302 an instructor inputs and transmits a code to request a new certification from a learning institution. At Step 304, the request is received by the learning institution for evaluating whether the new instructor certification should be granted. For the situation where the instructor believes that he or she is pre-certified in a particular subject matter area, at Step 306 the instructor sends a request for certification to the learning institution with a statement as to how the instruction is already certified (i.e., pre-certified) in a particular subject matter area. At Step 308, the request is received by the Seaming institution for verifying whether the pre-certification request should be granted. At least one purpose of an instructor certification process is to indicate quality to students or potential students. Another purpose may be to permit people looking for instructors to use the certifications as a filtering mechanism to see only instructors that are certified in particular subject areas.

At Step 310, the learning institution may accept or reject the request or requests for either new or pre-certified certification. If the learning institution accepts the request, then the instruction receives a notification from the learning institution that the requested certification has been granted. At Step 314, the learning institution may optionally update the instructor's profile or bio, or have the instructor do so, to digitally show that the instructor has been granted the certification. In one embodiment, the digital certification may take the form of a digital badge or other type of graphic that is placed on the instructor's profile and the instructor's certification in the particular subject matter area may be updated in a database operated by the learning institution. By way of example, the granted certification may appear as a digital badge on the instructor's profile alongside their name so that the badge appears when students are searching for an instructor or others are merely viewing marketplace search results.

If the certification request is denied or rejected, at Step 316 the learning institution may notify the requesting instructor and provide feedback for how the instructor may achieve certification. For example, the instructor may need more teaching hours or may need to update their teaching hours. Once the instructor receives such feedback, the instructor may initiate another new certification request at Step 302.

The learning institution may be provided a web portal that shows a list of tutors who have requested certification from that institution, and also show relevant information such as name, time of request, signup date, and a link to profile. In one embodiment, the web portal may be accessed securely. In another embodiment, the web portal may be accessed by the public. One advantage of such a web portal is that it minimizes the time needed by the staff of the learning institution when trying to certify multiple tutors.

In another embodiment, the learning institution may review all the new instructors that have signed up and then decide if the instructor deserves to be certified. Accordingly, the certification process may be initiated by the learning institution instead of the instructor. In yet another embodiment, the instructor may receive certification by obtaining training from the learning institution. Upon completion of the requisite training, the learning institution provides the new instructor a code which other instructors would not know, and then the instructor puts that code into an online education system, which in turn would authorize the certification.

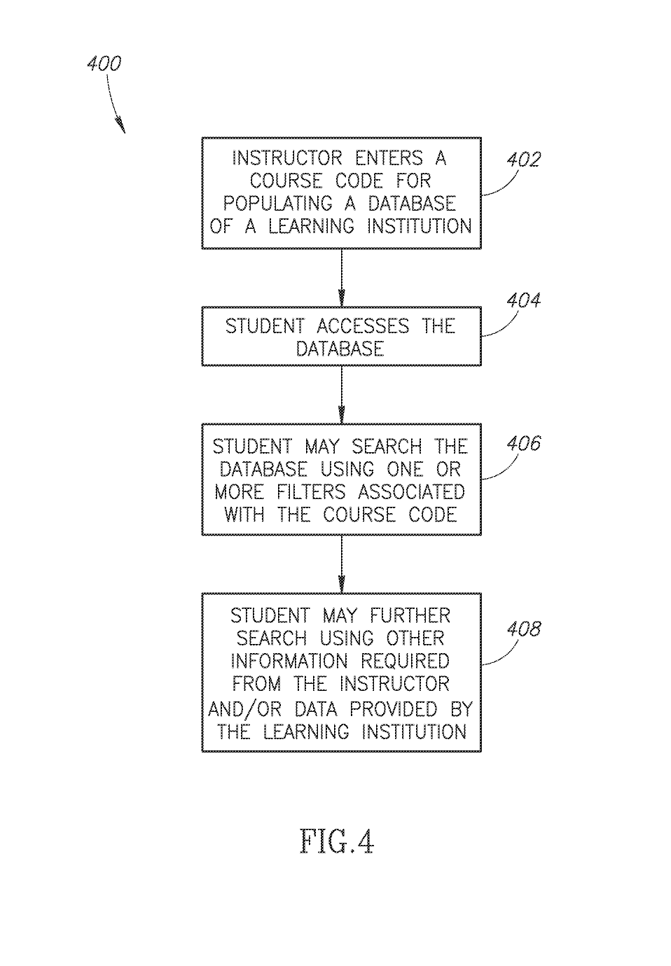

FIG. 4 shows a search method 400 that enables a student to search a course selection database of a learning institution based on one or more course codes provided by an instructor according to an embodiment of the present invention. At Step 402, the instructor enters a course code to populate or further populate the course selection database of the learning institution. By way of example, the course code may be appended with a shortened name for a course taught by the instructor. Generating such a database with the course codes may advantageously provide a faster way of populating the database as compared to a conventional method of populating a course selection database with a list of courses named by the learning institution because in many cases the course names may not be intuitively recognized by a student, especially by beginning or potential students.

At Step 404, one or more students may access or be given access to the course selection database. At Step 406, the student may search the database using one or more filters. At Step 408, the student may optionally utilize additional filters to search for courses using information such as, but not limited to information required from the instructor by the learning institution and course specific data provided by the learning institution (e.g., an instructor's certifications).

In another embodiment, the filters may not be associated with a course code. A course code is like ECON1100, a freshman economics course. The instructors input all the course codes in which they are qualified to teach, which populates a course code database. The student may search or filter the database by typing in the course code they are enrolled in or wish to enroll in. If a student is taking ECON1100, they can type that in and find the instructors that have inputted ECON1100 as one of the instructor's courses. This may eliminate the task of pre-loading ail the course codes for every learning institution. Instead, the instructors add course codes as they sign up, and that builds the course code database. Additionally or alternatively, students may search for courses by a course name instead of using the course code.

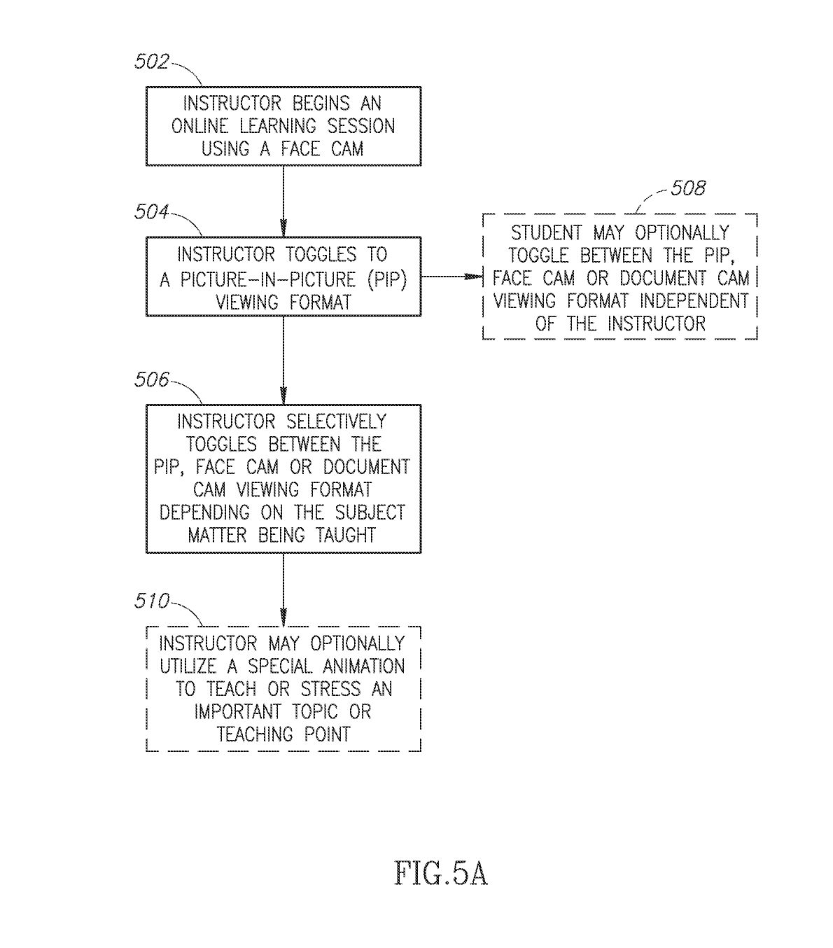

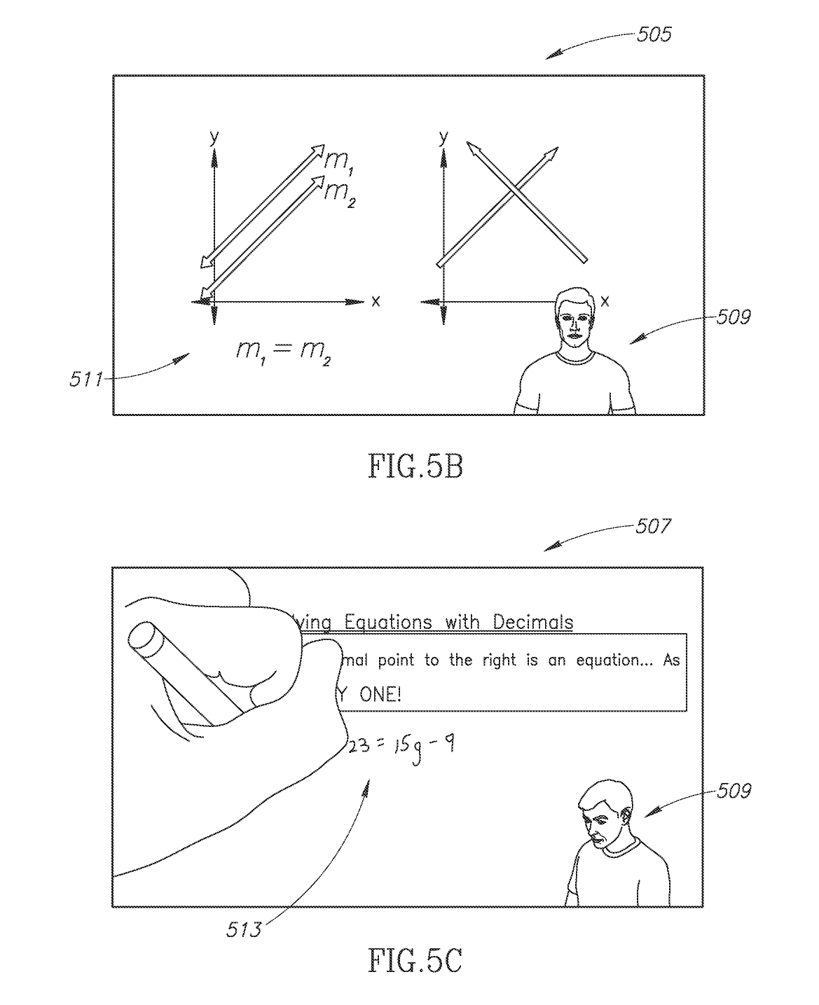

FIG. 5A shows a picture-in-picture (PIP) method 500 for improved interaction between a student and an instructor in an online educational or learning environment according to an embodiment of the present invention. The PIP method 500 allows the student to see the face and impression of the instructor while simultaneously allowing the student to see the content of the subject matter being taught. At Step 502, the instructor begins an online learning session using a face cam, which may take the form of a camera that shows at least the face of the instructor, but may show more of him or her depending on a setup of the camera and a distance from the camera to the instructor. A recording session may be done by a single person with no post editing. Instructors may adjust camera height and/or may use a special mixer to control different shots (face cam, animations, transitions, etc.) with one hand while continually filming so there is no need for post editing.

At Step 504 and after the instructor has introduced the subject matter to be taught in the session, the instructor toggles to the PIP viewing (i.e., from the student's perspective) format. FIGS. 5B and 5C show two embodiments of the PIP viewing format 505, 507, respectively. The instructor 509 is shown in a bottom right portion of the PIP viewing formats 505, 507 and the subject matter, 511, 513, respectively, is shown behind the instructor. At Step 506, the instructor selectively toggles between the PIP view format, a face cam viewing format (i.e., shows the instructor only without any subject matter or documents), or a document viewing format (i.e., showing subject matter or one or more documents without showing the instructor). Optionally at Step 508, the student may toggle between the PIP viewing format, the face cam viewing format or the document viewing format independent of the instructor. At Step 510, the instructor may optionally utilize a special animation to teach or stress one or more important topics, concepts or points of the subject matter being taught. In one embodiment, the special animation is shown in the PIP format. In one embodiment, a document camera's video feed is placed on a green screen behind the instructor, electronically. FIG. 5B shows the instructor looking at a camera (face cam) and then a document camera behind hung from the ceiling (‘doc cam’) and then a green screen behind the instructor. Moreover, the instructor may end a teaching lesson on the face cam to provide a summary of lesson.

Allowing the instructor to change the camera angle may permit or shift the student's focus. If the instructor goes to the face cam, the student should focus on listening to the instructor explain something, and really think about the concept. If the instructor goes to PIP format, it means that the instructor is implicitly showing the student that they need to be watching what the instructor is drawing.

During a teaching session, the student may want or need to pose a question to the instructor or share information with another student. When a student cannot answer a problem in their notes from class or a handout, it is difficult to recreate the problems by typing. Instead of typing it out the student may take a photo with a mobile device and post it to the class wall and ask their questions about it. By way of example, the student may take a photo of themselves pointing to a part of their notes they do not understand. Taking a photo is much easier than typing out long questions. The student is more likely to ask questions when it is easy to do so, and taking a photo and possibly adding some text with it (optional) is easier than typing an entire question. Additionally or alternatively, students may help each other by taking a photo that was posted by someone else, and then put it in a drawing program so one of the students may interact with the photo to point out, in real time, what needs to be modified or clarified.

When posing a question, the student may present the question on a virtual wall in the online learning environment, similar to a post on a social media site. The wall may operate as a discussion wall where students post questions and other students or the instructor may respond at any time after the post shows up on the wall (e.g., even days or weeks after the post appears on the wall). The wall may be attended to (i.e., questions answered) by the instructor or by a person assisting the instructor such as, but not limited to, a tutor. To close a post on the wall, the instructor or the instructor's assistant may take a final act to make the post closed.

The instructor may filter the wall for unclosed threads so the instructor can answer questions and close threads. For example, the instructor may filter out all the threads where an instructor is the last comment in the thread. If the last post in a thread is from an instructor, or if the instructor has liked the last post in the thread, then the thread may be closed. This would diminish or eliminate the need for other instructors to read though the closed thread. If the student replies back on the thread, then the thread may automatically re-open and the instructor may be notified that they should respond.

Another embodiment of the present invention is directed toward protecting content used in an online learning session and to prevent students or others from sharing or using a single student account. By way of example, the students would be required to log in with a username and a password that is the same or at least similar to a password used by the student for non-learning activities such as, but not limited logging into a social media site. Because students would want to keep access to their social media site private the student would be incentivized not to share their password for online learning with others.

Additionally or alternatively, the learning institution may charge for online learning content through a token system. The student purchases a package with a certain number of tokens and each piece of learning content (e.g., video, pdf) would require one or more tokens to be purchased or made available to the student. Such a token system may prevent students from sharing accounts with others since there is a limited amount that can be consumed. In another embodiment, the may use a payment system such as, but not limited to, a credit or debit card and receive monthly bills. Each successful monthly payment may result in a replenishment of the tokens allotted per month.

In yet another embodiment, when files are uploaded to a server through an administrative portal, the name of the document may be automatically changed to a random string of characters before the document is saved or stored on the server. Such an automated naming convention may also be advantageous in preventing students from saving content that is not supposed to be permanently saved by the student.

To prevent students from creating fake accounts and sharing it with others, the learning institution may have a friend threshold rule. By way of example, a one hundred (100) student friends rule may prevent students from watching videos if they have less than fifty (50) student friends. So if student created a fake account, the student would need to find fifty other student friends before the student would be allowed to watch any learning videos. This same rule may also prevent the student from purchasing learning items such as documents if the student has less than 100 friends. Since the student is first told they must have fifty student friends to watch a video, the student will not likely go all the way up to one hundred student friends before they purchase a learning item. When a student or another person attempts to purchase with less than one hundred student friends, the learning institution would transmit an error message, but does not necessarily need to disclose the reason for the error message. When contacted by the student, the learning institution may create an exception if it is determined the student does not have a social media account or if it is otherwise determined the student is not involved in a scam.

Additionally or alternatively, the learning institution may generate one or more reports that notify students whether they have watched one or more learning videos in a particular number of subjects over a predetermined number of days or weeks. In addition, the learning institution knows the specific combinations of courses that students are able to be enrolled in, and can identify those who are scamming by sharing accounts. For example, a student cannot be taking calculus II and calculus I at the same time. Students are also contacted and prevented from using resources if such behavior continues.

To prevent account sharing between learning institutions, the learning institution may generate a report that identifies students watching videos in two or more schools over a certain time period.

The content may take the form of existing content or new content. In one embodiment, the content may be uploaded to a database or server. By way of example, the process of uploading videos for a new class may start with the creation and organization of folders that represent chapters in the textbook. Within each chapter there may be some pre-recorded material (e.g., about eighty percent (80%)) and some custom material (e.g., about twenty percent (20%)). Because instructors may each teach a little differently the content may be selectively and deliberately adjusted, revised, re-organized, etc. by the instructor.

When a student posts on the virtual wall in the learning environment, the student selects their instructor. This selection permits the learning institution to know which students are associated with which instructor without needing to first obtain roster-information directly from instructor. Accordingly, the instructor may then tailor a response to the student based on the instructor's knowledge of the organization and content of his or her course.

In another embodiment, the learning institution may provide karma points to one or more students in an online learning environment. Generally, the issuance of karma points is reserved for instructors, which may include tutors. By way of example, karma points may be earned when a student directs a peer to a correct learning resource, guides a peer to a correct question on a wall, or otherwise provides an incentive or encouragement to another party to spend more time on the online learning site. Further, the students may answer another student's question, and then a moderator or the instructors could ensure accuracy and award karma points. Accordingly, the instructor does not have to be the one to answer a student's question, but instead another student answers a first student's question, and then the instructor verifies the answer.

In one embodiment, a leaderboard shows a monthly and a lifetime ranking of karma points earners. By way of example, a student may selectively filter the leaderboard to search for students in their learning institution. The leaderboard may also be set to automatically detect a grade level of the student (e.g., middle school versus high school). Thus, a middle school student would be restricted to viewing rankings of only other middle school students and a high school student would be restricted to viewing rankings of only other high school students. The karma point system may allow students to immediately compare themselves to their peers, and allow the instructor or the learning institution to create positive competitions.

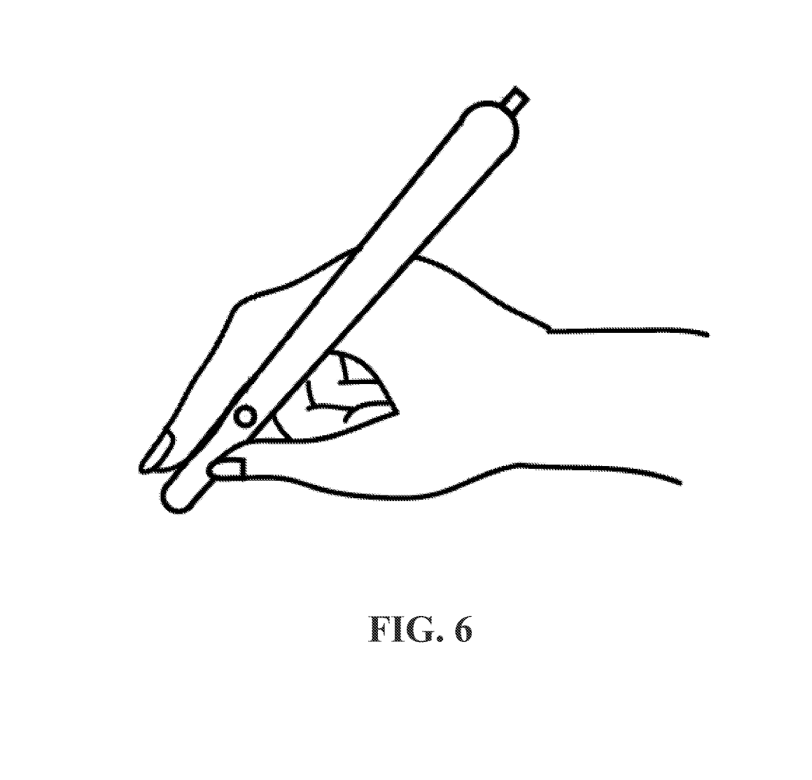

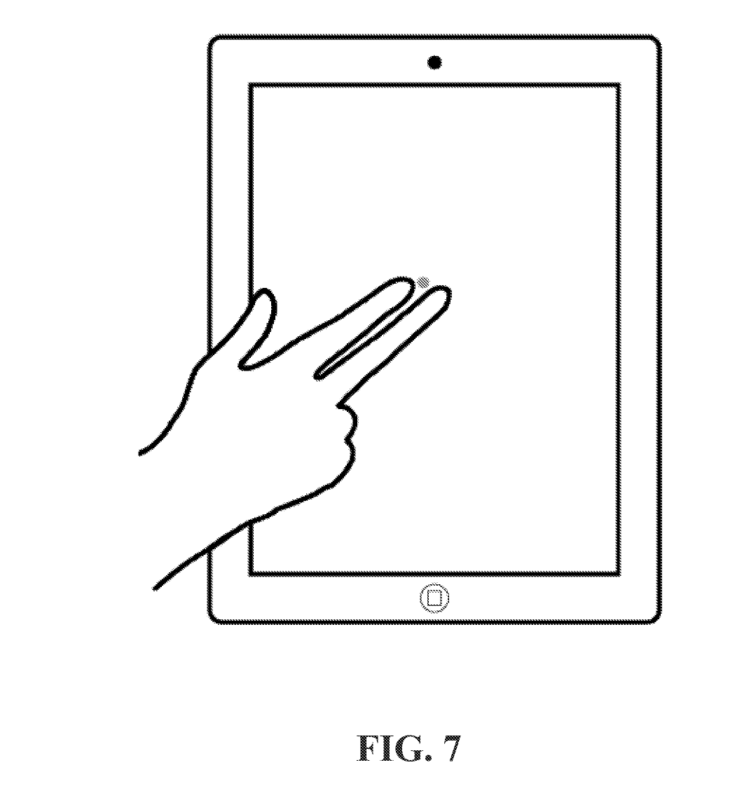

FIGS. 6 and 7 show a stylus that operates similar to a mechanical pencil. In one embodiment, the stylus includes a button that may be operated by a person's index finger wherein pressing that button shoot an electronic laser that puts the laser on the screen and you could point to stuff. Touching the stylus the stylus on the screen would cause the person to draw on the screen. Toggling the button would cause the stylus to function like a pointer or a laser pointer to allow pointing without drawing on the screen.

So that is if user number 1, who's the tutor, circles, user number 2, who's the tutee, sees the circle but then it dies out slowly it trails off, it kind of fades away. So yeah that's part of it. You could also do it with a push button, you know like with a normal ball point pen where you click to let it out or let it in, you could click with your thumb and that would turn on either writing, or you could click it again and it would be a laser pointer. And if you clicked again it would be back to writing and if you clicked again it would be a laser pointer.

Anyway, there are people with styluses, the point is to add a button either under your index finger or under your thumb or at the top of the stylus where you would click it like where the eraser would be on a pencil. You would click that and, or you would hold it down with your index finger, or click it with your thumb, but if you held it down with your index finger, if you were holding the button that would mean that it would not draw. It would just do a temporary laser pointer trail. When you're private tutoring somebody in person, the one thing that you're able to do that you're not able to do online is to point at stuff. Like when you're sitting and showing somebody something, you point at different parts of the paper.

A special pen, stylus, or writing device may emit a wireless signal (such as bluetooth, will, ultrasonic) when the laser pointer button is pressed. This button may either toggle on/off the laser pointer tool or may turn the laser pointer tool on so long as the button remains depressed. The wireless signal that is triggered by this button may tell the device and subsequently the application to stop writing on the screen and instead show a dot that may not leave a trace or mark up the screen.

Note that the dot may have a particular, a particular shape, and may provide a trail. But optionally advantageous is that it does not affect the actual drawing. Or it could affect the actual drawing.

Also note that the stylus could be pressed against the screen to write or to point with the laser, or it could be held in the air and the direction of the stylus could be determined by the screen/device. So you could point like with a laser pointer at a conference when you point at a presentation with your real laser pointer, but the difference here is that the person on the other end of the video conference would see the laser pointing on their screen, when the teacher is touching the stylus to the screen or holding down the button. Would the teacher may also see the laser dot the teacher's own screen. However, it might not be necessary because if the teacher is touching the screen with the stylus, the teacher knows where the teacher is pointing. It's the student who is across the world and can't see that the stylus is touching the screen or where it's touching the screen. So the student would be the one who really needs to see the laser red dot or whatever it is. So the dot could be created when the stylus is touching the screen or when the stylus is pointing at the screen, but not touching it. And the dot would be turned on and off either by touching a spot on the screen, or depressing the button on the stylus, or holding down the button on the stylus. Also, TWO users could both have these devices. And it could be a blue dot or other color and shape for one user vs. red for the other user. OR, both users could use red dots, but each user would only see ONE red dot (the other user's pointer/laser). So it wouldn't be a problem of confusion for either user. Also, the teacher could use their finger to point and the stylus to write.

While the preferred embodiment of the invention has been illustrated and described, as noted above, many changes can be made without departing from the spirit and scope of the invention. In addition, other advantages will also be apparent to those of skill in the art with respect to any of the above-described embodiments whether viewed individually or in some combination thereof. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for matching instructors and students, the method comprising:
generating a database of instructors from one or more learning institutions;
determining whether an instructor is friends with or has mutual friends with a student;
providing a personality test to the student to determine a learning type of the student; and
permitting the student to select an instructor.

2. The method of claim 1, further comprising providing at least one name of the instructor before the student takes the personality test.

3. The method of claim 1, wherein determining whether the instructor is friends with or has mutual friends with the student includes not sending a message to the student if no friends or no mutual friends are found.

4. The method of claim 1, wherein determining whether the instructor is friends with or has mutual friends with the student includes checking a social media site that the student and the instructor have in common.

5. The method of claim 4, wherein the providing the personality test to the student includes providing a quasi-Meyers-Briggs personality test.

6. The method of claim 1, wherein determining the learning type of the student includes determining whether the student learns better from examples first or from concepts first.

7. The method of claim 1, further comprising providing additional criteria to assist the student in selecting the instructor.

8. The method of claim 7, wherein the additional criteria includes an instructor rank or score.

9. The method of claim 7, wherein the additional criteria includes a number of teaching hours that have been completed by the instructor.

10. The method of claim 7, wherein the additional criteria includes a certification of the instructor.

11. A method for instructor certification from a learning institution, the method comprising:
receiving a request for a new certification from an instructor;
evaluating the request for the new certification; and
determining whether the request should be accepted or rejected.

12. The method of claim 11, wherein determining that the request should be rejected includes providing feedback to the instructor as to how to achieve the requested certification.

13. A method for instructor certification from a learning institution, the method comprising:
receiving a request for a certification from an instructor, wherein the instructor believes that the instructor is pre-certified;
verifying the request for the certification; and
determining whether the request should be accepted or rejected.

14. The method of claim 13, wherein determining that the request should be rejected includes providing feedback to the instructor as to how to achieve the requested certification.

15. A method for viewing an online learning session, the method comprising:
commencing an online learning session in which an instructor is initially viewable by the students through a face camera;
toggling a viewing format of the online learning session to a picture-in-picture (PIP) viewing format; and
depending on subject being taught by the instructor, selectively toggling the viewing format between the PIP viewing format, the face camera viewing format, and a document camera viewing format.

16. The method of claim 15, wherein toggling the viewing format is initiated by the instructor.

17. The method of claim 15, wherein toggling the viewing format is initiated by the student.

18. The method of claim 15, further comprising showing an animation in the viewing format to teach or stress an important topic or an important teaching point.
